(19) United States
(12) Patent Application Publication
(10) Pub. No.: US 2017/0307292 A1
(43) Pub. Date: Oct. 26, 2017

(54) AUTOMATIC DRYING METHOD AND AUTOMATIC DRYING DEVICE FOR A GRAIN DRYER

(71) Applicant: SUNCUE COMPANY LTD., TAICHUNG CITY (TW)

(72) Inventor: JUNG-LANG LIN, TAICHUNG CITY (TW)

(21) Appl. No.: 15/134,790

(22) Filed: Apr. 21, 2016

(51) Int. Cl. F26B 25/22; F26B 17/12; F26B 3/04; F26B 21/10; F26B 23/02

(52) U.S. Cl. CPC F26B 25/22; F26B 21/10; F26B 23/028; F26B 3/04; F26B 17/122; F26B 2200/06

(57) ABSTRACT

An automatic drying method for a grain dryer has a preparing step, a parameter-setting step, and a multi-stage drying step. The preparing step includes preparing an automatic drying device. The automatic drying device has a body, at least two drying sections, and a detecting module. Each drying section has a hot air inlet, a net-layer base, and at least one exhaust pipe. The detecting module is connected to the body and has at least two moisture meters, at least two temperature sensors, a rotary unit, and a processing unit. The parameter-setting step comprises setting a temperature value and a moisture content of each drying section. The multi-stage drying step comprises conveying pre-dried grains into each drying section, importing hot air into each drying section to dry the pre-dried grains, and adjusting an operating speed of the rotary unit and the temperature of the hot air.

### BACKGROUND OF THE INVENTION

### 1. Field of the Invention

The present invention relates to an automatic drying method and an automatic drying device, and more particularly to an automatic drying method and an automatic drying device for a grain dryer that may provide a multi-detecting effect, may reduce the number of repeated drying, and may reduce the cost of using the automatic drying method and the automatic drying device for the grain dryer.

### 2. Description of Related Art

Grains such as rice, wheat or coffee beans need to be processed by a shelling process, and the husks that are shelled from the grains can be used as biomass fuels for a conventional grain dryer. A heat source that is generated by burning the biomass fuels in a conventional grain dryer may be used to dry or adjust the moisture content of the grains, and this may achieve an effect of resource recovery and reuse. The conventional grain dryer may be broadly divided into two categories such as a continuous-type grain dryer and a circulating-type grain dryer. The continuous-type grain dryer may deliver grains continuously into the grain dryer to dry by a transport mechanism. In addition, the circulating-type grain dryer may dry grains by a circular transporting way when grains have filled in the grain dryer.

Furthermore, the conventional grain dryer has a burner, a smoke pipe, a heat exchange unit, an exhaust pipe, a drying unit, and a chimney pipe group. The burner has an internal combustion furnace to burn the biomass fuels to generate thermal energy. The smoke pipe communicates with a top end of the internal combustion furnace to guide and exhaust the fuel gas generated from burning the biomass fuels. The heat exchange unit communicates with the smoke pipe and exchanges heat with the outside cold air. The exhaust pipe communicates with the heat exchange unit to guide the hot air after heat exchanging. The dry unit communicates with the exhaust pipe to enable the hot air in the exhaust pipe to flow into the dry unit to dry the grains. The chimney pipe group communicates with the heat exchange unit to guide and exhaust the fuel gas to the outside after heat exchanging.

However, when the conventional continuous-type grain dryer is in use, the moisture value of the grains in the dry unit may be detected only after the entire drying process. The grains must be dried again if the moisture value of the grains is too high. Then, the repeated drying process may increase the time of drying the grains and may also increase the consumption of energy and the cost of use. In addition, if the moisture value of the grains that have been processed by the conventional grain dryer is higher or lower than a set value, the grains after drying may not meet the user's needs.

To overcome the shortcomings, the present invention provides an automatic drying method and an automatic drying device for a grain dryer to mitigate or obviate the aforementioned problems.

### SUMMARY OF THE INVENTION

The main objective of the present invention is to provide an automatic drying method and an automatic drying device, and more particularly to an automatic drying method and an automatic drying device for a grain dryer that may provide a multi-detecting effect, may reduce the number of repeated drying, and may reduce the cost of using the automatic drying method and the automatic drying device for the grain dryer.

The automatic drying method for a grain dryer in accordance with the present invention has a preparing step, a parameter-setting step, and a multi-stage drying step. The preparing step includes preparing an automatic drying device. The automatic drying device has a body, at least two drying sections, and a detecting module. Each drying section has a hot air inlet, a net-layer base, and at least one exhaust pipe. The detecting module is connected to the body and has at least two moisture meters, at least two temperature sensors, a rotary unit, and a processing unit. The parameter-setting step comprises setting a temperature value and a moisture content of each drying section. The multi-stage drying step comprises conveying pre-dried grains into each drying section, importing hot air into each drying section to dry the pre-dried grains, and adjusting an operating speed of the rotary unit and the temperature of the hot air.

Other objectives, advantages and novel features of the invention will become more apparent from the following detailed description when taken in conjunction with the accompanying drawings.

### BRIEF DESCRIPTION OF THE DRAWINGS

FIG. 1 is a block diagram of an automatic drying method for a grain dryer in accordance with the present invention;

FIG. 2 is a perspective view of an automatic drying device for a grain dryer in accordance with the present invention;

FIG. 3 is a side view of the automatic drying device for a grain dryer in FIG. 2;

FIG. 4 is another side view of the automatic drying device for a grain dryer in FIG. 2;

FIG. 5 is a side view in partial section of the automatic drying device in FIG. 4;

FIG. 6 is an operational block diagram of the automatic drying device in FIG. 2 under a drying process;

FIG. 7 is an operational side view in partial section of the automatic drying device in FIG. 4; and

FIG. 8 is an operational block diagram of the automatic drying device in accordance with the present invention with multi-stage drying under a drying process.

### DETAILED DESCRIPTION OF THE PREFERRED EMBODIMENT

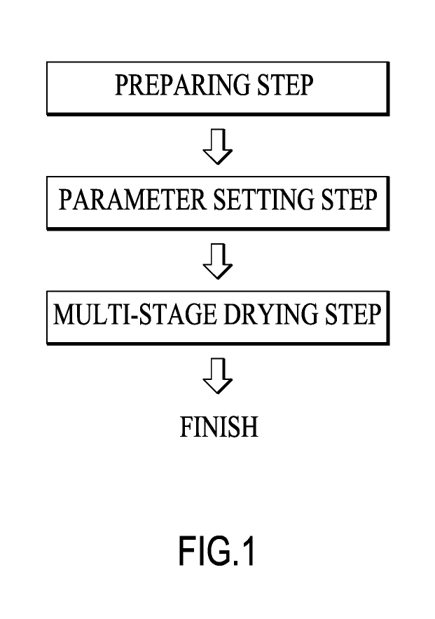

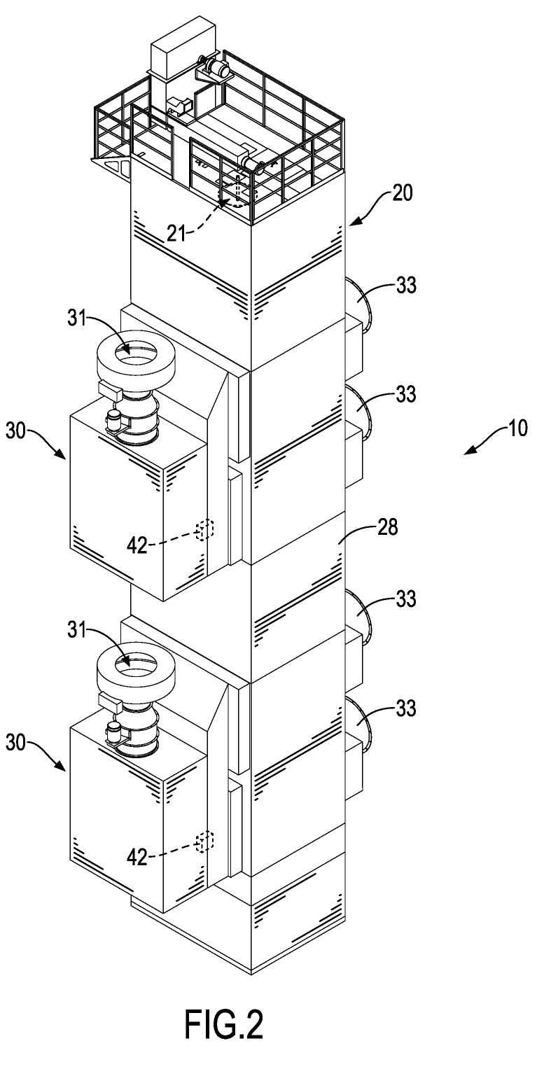

With reference to FIGS. 1 and 2, an automatic drying method for a grain dryer in accordance with the present invention has a preparing step, a parameter-setting step, and a multi-stage drying step.

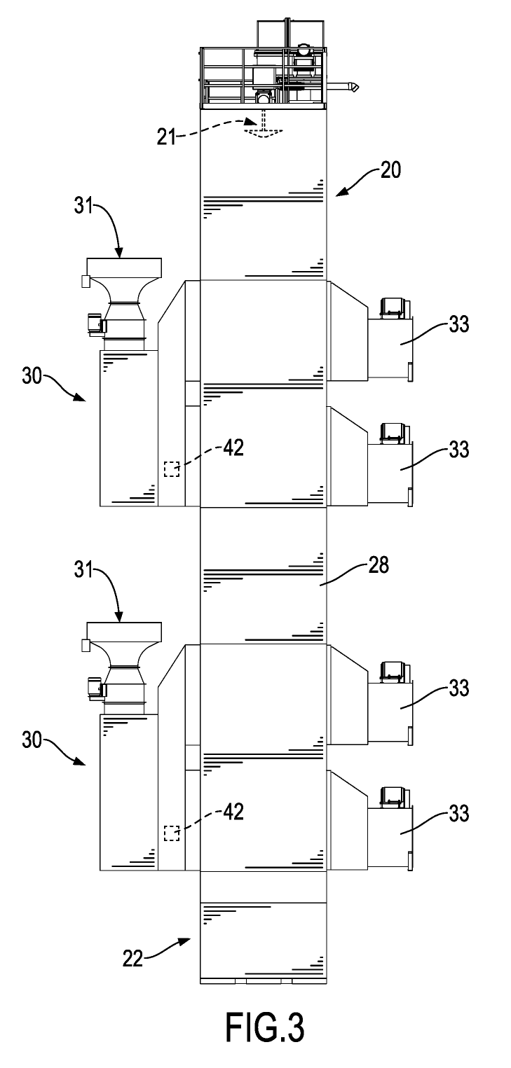

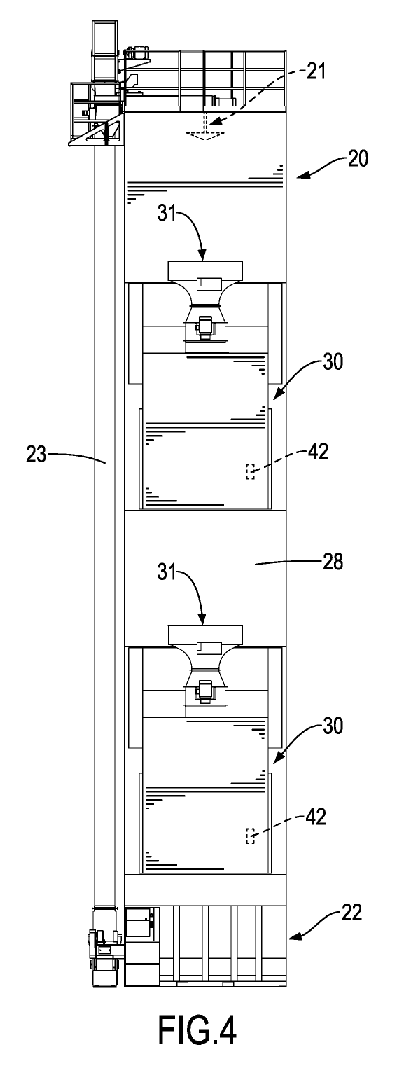

The preparing step comprises preparing an automatic drying device 10. Furthermore, the automatic drying device 10 may be a continuous-type grain dryer or a circulating-type grain dryer. With reference to FIGS. 3 to 5, the automatic drying device 10 has a body 20, at least two drying sections 30, and a detecting module 40.

The body 20 has an interior, an exterior, a top end, a bottom end, an input portion 21, an output portion 22, and a conduit pipe 23. The interior is formed in the body 20 between the top end and the bottom end of the body 20. The input portion 21 is deposited on the top end of the body 20. Furthermore, the body 20 has a spreading tray 24 deposited in the input portion 21 of the body 20. The output portion 22 is deposited on the bottom end of the body 20.

Additionally, the body 20 further has a receiving box 25 and an output rod 26 deposited in the output portion 22 of the body 20. The receiving box 25 is connected to the bottom end of the body 20 below the spreading tray 24, and communicates with the interior of the body 20. The output rod 26 is rotatably mounted in the receiving box 25. Furthermore, the output rod 26 is a screw rod and is driven by a driving motor 27.

The conduit pipe 23 is mounted on the exterior of the body 20, communicates with the input portion 21 and the output portion 22 to convey pre-dried grains into the interior of the body 20 via the conduit pipe 23 and the input portion 21, and convey pre-dried grains into the conduit pipe 23 via the output portion 22.

The at least two drying sections 30 are connected to the body 20 at a spaced interval between the input portion 21 and the output portion 22, and each one of the at least two drying sections 30 has a hot air inlet 31, a net-layer base 32, and at least one exhaust pipe 33. The hot air inlet 31 is deposited on the exterior of the body 20 and communicates with the interior of the body 20. The net-layer base 32 is mounted in the interior of the body 20 and communicates with the hot air inlet 31. The at least one exhaust pipe 33 is deposited on the exterior of the body 20 and communicates with the net-layer base 32. In addition, the body 20 has a buffer layer 28 mounted between two adjacent drying sections 30 to change the flow directions of the hot air in the two adjacent drying sections 30. Furthermore, the automatic drying device 10 has multiple drying sections 30.

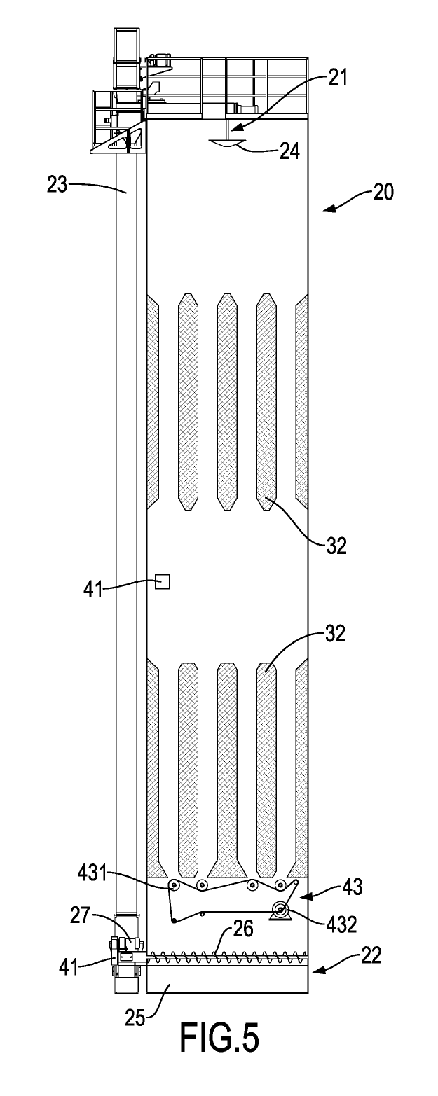

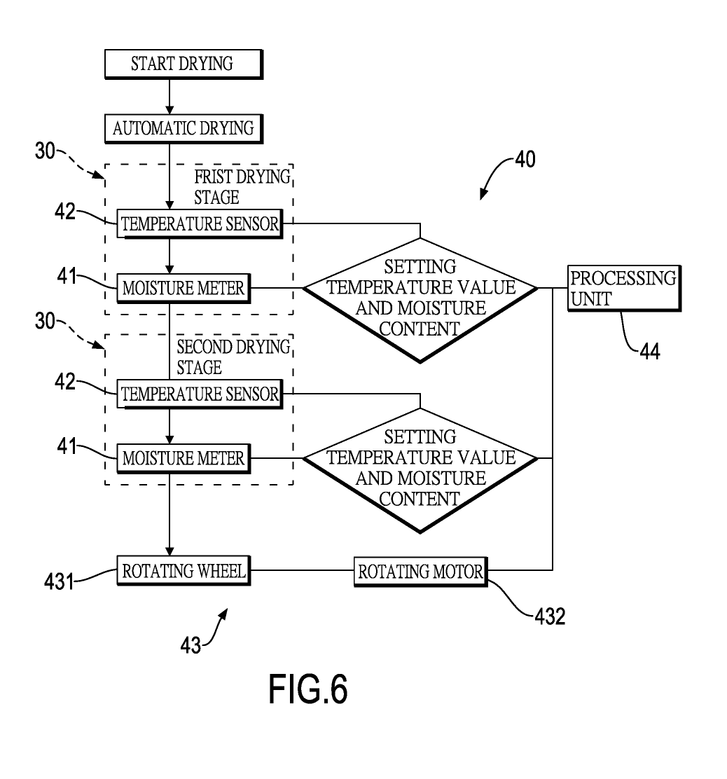

With reference to FIGS. 5 and 6, the detecting module 40 is connected to the body 20 and has at least two moisture meters 41, at least two temperature sensors 42, a rotary unit 43, and a processing unit 44. The at least two moisture meters 41 are connected to the body 20 to enable each one of the at least two moisture meters 41 to mount below one of the net-layer bases 32 of the at least two drying sections 30, and each one of the at least two moisture meters 41 is used to detect the moisture content at a corresponding net-layer base 32.

Each one of the at least two temperature sensors 42 is mounted in one of the at least two drying sections 30 to detect the temperature of a corresponding drying section 30. The rotary unit 43 is mounted in the body 20 and has multiple rotating wheels 431 and a rotating motor 432. The rotating wheels 431 are rotatably mounted in the body 20 below a bottommost net-layer base 32. The rotating motor 432 is mounted in the body 20, and is connected to the rotating wheels 431 by a belt to enable the rotating wheels 431 to rotate relative to the body 20. In addition, the rotating motor 432 is a frequency control motor.

The processing unit 44 is electrically connected to each one of the at least two moisture meters 41, and is electrically connected to each one of the at least two temperature sensors 42 and the rotary unit 43. Then, the processing unit 44 may calculate and process the detected signals provided by each one of the at least two moisture meters 41 to compute a data, to increase or lower the temperature of the hot air according to the data, and increase or lower the operating speed of the rotating wheels 431 by the rotating motor 432. In addition, the processing unit 44 is a microcomputer.

The parameter-setting step comprises setting a temperature value and a moisture content of each one of the at least two drying sections 30 by the processing unit 44 according to a user's need.

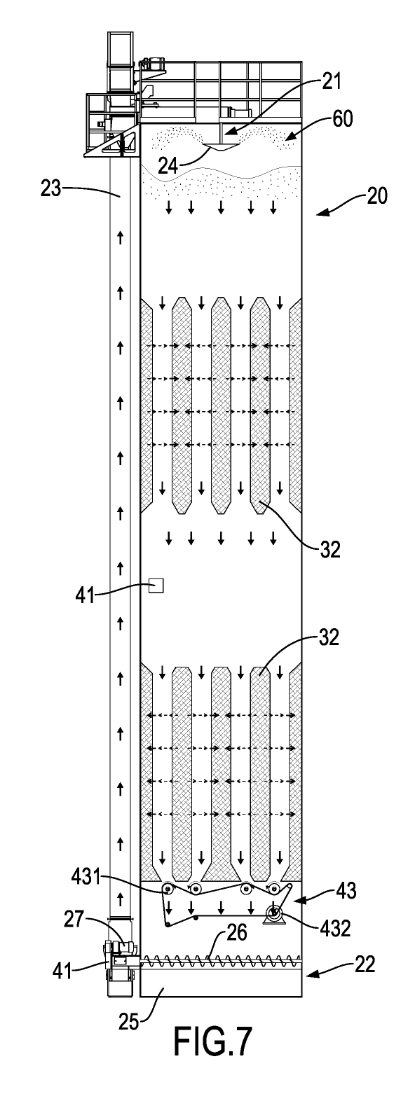

With reference to FIG. 7, the multi-stage drying step comprises conveying pre-dried grains 60 into the input portion 22 of the body 20 via the conduit pipe 23, guiding the pre-dried grains 60 into each one of the at least two drying sections 30 via the spreading tray 24, importing hot air into the net-layer base 32 of each one of the at least two drying sections 30 via the hot air inlet 31 to enable the pre-dried grains 60 to absorb the thermal energy from the hot air to discharge water when the pre-dried grains 60 passed through the net-layer base 32 of each one of the at least two drying sections 30, exhausting the hot air out of the body 20 via the at least one exhaust pipe 33 of each one of the at least two drying sections 30 after passing through the pre-dried grains 60, detecting the temperature value and the moisture content of each one of the at least two drying sections 30 respectively by the corresponding temperature sensor 42 and moisture meter 41, transferring signals corresponding to the temperature value and the moisture content of each one of the at least two drying sections 30 to the processing unit 44, increasing the temperature of each one of the at least two drying sections 30 when the moisture content of each one of the at least two drying sections 30 is higher than the set moisture content of each one of the at least two drying sections 30, decreasing the temperature of each one of the at least two drying sections 30 when the moisture content of each one of the at least two drying sections 30 is lower than the set moisture content of each one of the at least two drying sections 30, calculating an overall precipitation rate of the pre-dried grains 60, adjusting (increasing or decreasing) the operating speed of each one of the rotating wheels 431 by the processing unit 44, sending a signal to the rotating motor 432 and adjusting the temperature of the hot air.

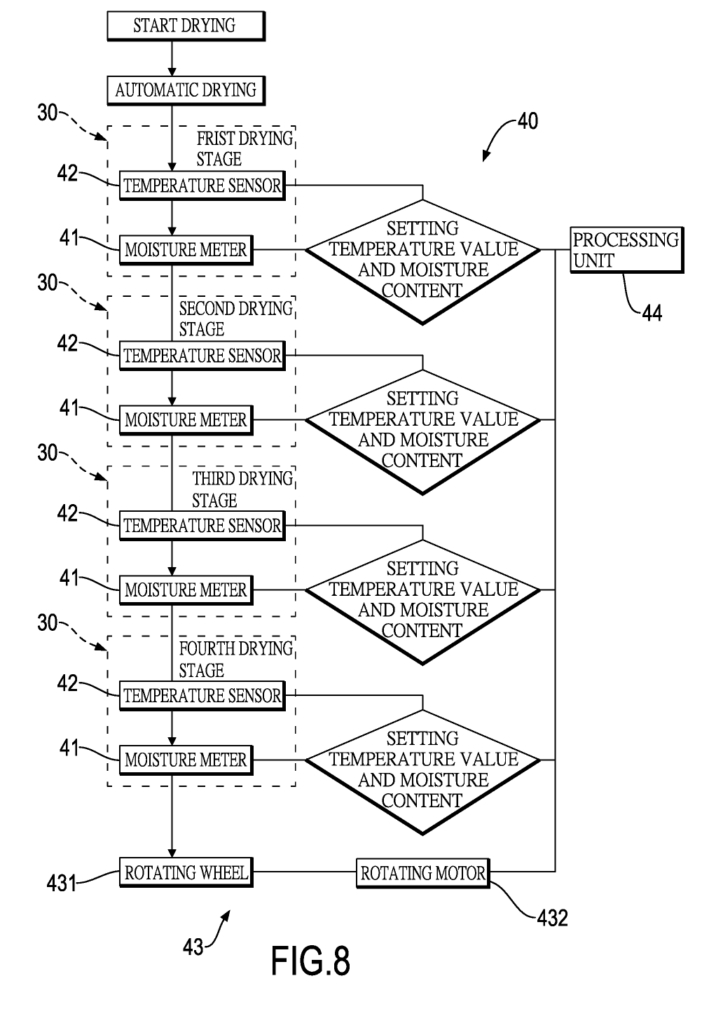

The overall precipitation rate of the pre-dried grains 60 is defined by the moisture content before dried, the moisture content after dried, and the characteristics of the pre-dried grains 60. Furthermore, when the automatic drying device 10 has four drying sections 30, the operation process of the automatic drying device 10 is shown in FIG. 8.

According to the above-mentioned statements, when the automatic drying method and the automatic drying device for a grain dryer of the present invention is in use, multiple drying sections 30 may be connected to the body 20 to enable the pre-dried grains 60 to be dried by sequentially passing through the drying sections 30. In addition, the temperature value and the moisture content of each one of the drying sections 30 can be set independently. Furthermore, the temperature sensors 42 and the moisture meters 41 of the detecting module 40 are respectively deposited in each one of the drying sections 30 to detect the moisture content of the pre-dried grains 60 in each one of the drying sections 30, and this may provide a multi-stage detecting effect to the pre-dried grains 60. When the moisture content of the pre-dried grains 60 does not meet the set moisture content of each one of the drying sections 30, the temperature and conveying speed of each one of the drying sections 30 can be adjusted to enable the moisture content of the pre-dried grains 60 to meet the set moisture content of each one of the drying sections 30.

Then, the user may predetermine the moisture content of the pre-dried grains 60 in each one of the drying sections 30, and this may reduce the time to repeatedly drying the pre-dried grains 60, the consumption of energy, and the cost of use. Furthermore, the numbers of the drying sections 30 to enable the pre-dried grains 60 to pass through can be adjusted according to the user's need. That is, all of the drying sections 30 may not start at the same time, and this may further meet the requirements of energy-saving and low cost.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. An automatic drying method for a grain dryer having:
a preparing step comprising:
preparing an automatic drying device having a body, at least two drying sections, and a detecting module;
forming an interior in the body;
depositing an input portion on a top end of the body;
depositing an output portion on a bottom end of the body;
mounting a conduit pipe on an exterior of the body to communicate with the input portion and the output portion;
connecting the at least two drying sections to the body at a spaced interval between the input portion and the output portion of the body, and each one of the at least two drying sections having a hot air inlet, a net-layer base, and at least one exhaust pipe;
depositing the hot air inlet of each one of the at least two drying sections on the exterior of the body to communicate with the interior of the body;
mounting the net-layer base of each one of the at least two drying sections in the interior of the body to communicate with the hot air inlet;
depositing the at least one exhaust pipe of each one of the at least two drying sections on the exterior of the body to communicate with the net-layer base of the drying section;
connecting the detecting module to the body with at least two moisture meters, at least two temperature sensors, a rotary unit, and a processing unit;
connecting the at least two moisture meters to the body to enable each one of the at least two moisture meters to mount below one of the net-layer bases of the at least two drying sections to detect the moisture content of a corresponding net-layer base;
mounting each one of the at least two temperature sensors in one of the at least two drying sections to detect the temperature of said corresponding drying section;
mounting the rotary unit in the body; and
connecting the pressing unit electrically to each one of the at least two moisture meters, each one of the at least two temperature sensors, and the rotary unit;
a parameter-setting step comprising setting a temperature value and a moisture content of each one of the at least two drying sections by the processing unit; and
a multi-stage drying step comprising:
conveying pre-dried grains into each one of the at least two drying sections via the input portion and the conduit pipe of the body;
importing hot air into the net-layer base of each one of the at least two drying sections via the hot air inlet to enable the pre-dried grains to absorb the thermal energy from the hot air to discharge water when the pre-dried grains pass through the net-layer base of each one of the at least two drying sections;
exhausting the hot air out of the body via the at least one exhaust pipe of each one of the at least two drying sections after the hot air passes through the pre-dried grains;
detecting the temperature value and the moisture content of each one of the at least two drying sections respectively by the corresponding temperature sensor and moisture meter;
transferring signals corresponding to the temperature value and the moisture content of each one of the at least two sections to the processing unit;
adjusting the temperature of each one of the at least two drying sections when the moisture content of each one of the at least two drying sections is different from the preset moisture content of each one of the at least two drying sections;
calculating an overall precipitation rate of the pre-dried grains; and
adjusting an operating speed of the rotary unit by the processing unit, sending a signal to the rotary unit and adjusting the temperature of the hot air.

2. The automatic drying method claimed in claim 1, wherein the preparing step comprises connecting multiple drying sections to the body of the automatic drying device.

3. The automatic drying method claimed in claim 1, wherein the preparing step comprises
mounting multiple rotating wheels rotatably in the body below a bottommost net-layer base; and
mounting a rotating motor in the body to connect with the rotating wheels to enable the rotating wheels to rotate relative to the body.

4. The automatic drying method as claimed in claim 2, wherein the preparing step comprises
mounting multiple rotating wheels rotatably in the body below a bottommost net-layer base; and
mounting a rotating motor in the body to connect with the rotating wheels to enable the rotating wheels to rotate relative to the body.

5. The automatic drying method as claimed in claim 3, wherein the parameter-setting step comprises setting the temperature value and the moisture content of each one of the at least two drying sections by the processing unit according to a user's need.

6. The automatic drying method as claimed in claim 4, wherein the parameter-setting step comprises setting the temperature value and the moisture content of each one of the at least two drying sections by the processing unit according to a user's need.

7. An automatic drying device for a grain dryer having:
a body having
a top end;
a bottom end;
an interior formed in the body between the top end and the bottom end of the body;
an exterior;
an input portion deposited on the top end of the body;
an output portion deposited on the bottom end of the body; and
a conduit pipe mounted on the exterior of the body and communicating with the input portion and the output portion;
at least two drying sections connected to the body at a spaced interval between the input portion and the output portion, and each one of the at least two drying sections having
a hot air inlet deposited on the exterior of the body and communicating with the interior of the body;
a net-layer base mounted in the interior of the body and communicating with the hot air inlet; and
at least one exhaust pipe deposited on the exterior of the body and communicating with the net-layer base; and
a detecting module connected to the body and having
at least two moisture meters connected to the body to enable each one of the at least two moisture meters to mount below one of the net-layer bases of the at least two drying sections;
at least two temperature sensors, and each one of the at least two temperature sensors mounted in one of the at least two drying sections;
a rotary unit mounted in the body; and
a processing unit electrically connected to each one of the at least two moisture meters, each one of the at least two temperature sensors, and the rotary unit to calculate and process detected signals provided by each one of the at least two moisture meters to compute data and to adjust an operating speed of the rotary unit.

8. The automatic drying device as claimed in claim 7, wherein the automatic drying device has multiple drying sections connected to the body at spaced intervals between the input portion and the output portion of the body.

9. The automatic drying device as claimed in claim 7, wherein the rotary unit has
multiple rotating wheels rotatably mounted in the body below a bottommost net-layer base; and
a rotating motor mounted in the body and connected to the rotating wheels to enable the rotating wheels to rotate relative to the body.

10. The automatic drying device as claimed in claim 8, wherein the rotary unit has
multiple rotating wheels rotatably mounted in the body below a bottommost net-layer base; and
a rotating motor mounted in the body and connected to the rotating wheels to enable the rotating wheels to rotate relative to the body.

11. The automatic drying device as claimed in claim 9, wherein the body has
a spreading tray deposited in the input portion of the body;
a receiving box deposited in the output portion of the body, connected to the bottom end of the body below the spreading tray, and communicating with the interior of the body; and
an output rod deposited in the output portion of the body and rotatably mounted in the receiving box.

12. The automatic drying device as claimed in claim 10, wherein the body has
a spreading tray deposited in the input portion of the body;
a receiving box deposited in the output portion of the body, connected to the bottom end of the body below the spreading tray, and communicating with the interior of the body; and
an output rod deposited in the output portion of the body and rotatably mounted in the receiving box.

13. The automatic drying device as claimed in claim 11, wherein the body has a buffer layer mounted between two adjacent drying sections to change the flow directions of hot air in the two adjacent drying sections.

14. The automatic drying device as claimed in claim 12, wherein the body has a buffer layer mounted between two adjacent drying sections to change the flow directions of hot air in the two adjacent drying sections.

15. The automatic drying device as claimed in claim 13, wherein the output rod is a screw rod and is driven by a driving motor;
the rotating motor is a frequency control motor; and
the processing unit is a microcomputer.

16. The automatic drying device as claimed in claim 14, wherein the output rod is a screw rod and is driven by a driving motor;
the rotating motor is a frequency control motor; and
the processing unit is a microcomputer.
